(19) United States
(12) Patent Application Publication
(10) Pub. No.: US 2012/0272944 A1
(43) Pub. Date: Nov. 1, 2012

(54) WIRE SAW WORK PIECE SUPPORT DEVICE, SUPPORT SPACER AND METHOD OF SAWING USING SAME

(75) Inventors: Fabrice Coustier, Chambery (FR); Frédérique Lombard de Buffières, Bioley-Orjulaz (CH); Guillaume Mercay, Prilly (CH)

(73) Assignee: APPLIED MATERIALS, INC., Santa Clara, CA (US)

(21) Appl. No.: 13/496,911

(22) PCT Filed: Sep. 18, 2009
(86) PCT No.: PCT/EP2009/062150

§ 371 Date: Jul. 2, 2012

(51) Int. Cl. B28D 7/04; B28D 5/04

(52) U.S. Cl. 125/21; 125/35; 29/559

(57) ABSTRACT

A wire saw work piece support device (200) has a support surface (214, 314) adapted for supporting a work piece (100) being sawed by a wire saw (1) during sawing, the support surface (214, 314) defining a support plane. The wire saw work piece support device comprises: a solid support body (210); and at least one wire receiving volume (220, 230) for receiving therein a wire (10) of the wire saw 1 during sawing, the at least one wire receiving volume (220, 230) having a work piece side delimited by the support plane, and a base side delimited by a surface portion (224) of the solid support body (210), wherein the at least one wire receiving volume (220, 230) has a thickness between the work piece side and the base side of at least 60 mm in a direction orthogonal to the support plane.

### FIELD OF THE INVENTION

Aspects of the present invention relate to a wire saw work piece support device for supporting a work piece being sawed by a wire saw during sawing. More particularly, the work piece may be a hard material such as a block of silicon or quartz, e.g., for a silicon wafer. The wire saw may be a squarer, a cropper or the like. Further aspects of the present invention relate to a wire saw work piece support spacer adapted for a wire saw work piece support device, and to a method of sawing a work piece using a wire saw.

### BACKGROUND OF THE INVENTION

Wire saw devices exist for cutting blocks or bricks, thin slices, e.g., semiconductor wafers, from a piece of hard material such as silicon. In such devices a stretched wire is fed from a spool and is both guided and tensioned by wire guide cylinders. For sawing, a wire web is created by the wire being guided by the guide cylinders. The wire web includes sawing wire sections, which are the portions of the wire web in which the actual sawing is performed, i.e., at which a cut is created in the work piece.

The wire that is used for sawing is generally provided with an abrasive material. As one option, the abrasive material can be provided as a slurry. This may be done shortly before the wire touches the material to be cut. Thereby, the abrasive is carried to the cutting position by the wire for cutting the material. As another option, the abrasive can be provided on the wire with a coating. For example, diamond particles can be provided on a metal wire with a coating, wherein the diamond particles are imbedded in the coating of the wire. Thereby, the abrasive is firmly connected with the wire.

Generally, the productivity of a wire saw is limited by several factors including the cutting speed (which in turn depends on parameters such as the speed at which the wire is transported, the abrasive used, etc.), the number of work pieces that can be sawed in parallel, the failure rate resulting in maintenance downtime, and other downtime. For wire saws that cut silicon ingots or blocks used for solar panels, the productivity can be given in MW of solar panels sawed per hour.

After the sawing of a work piece (e.g., a semiconductor ingot or semiconductor block, for example for solar panels) has been completed, the sawing wire sections of the wire web have been moved into or through the ingot thereby creating a cut therein. Due to their finite tension, the sawing wire sections do not form a perfectly straight line during sawing, but they rather form a bow, with the parts closer to a border of the work piece having cut more through the work piece than the parts that are deeper in the interior of the work piece. The bow can have a different shape for each of the wire saw sections, depending on their relative tension. Due to these bows, it is difficult to define a proper end of the sawing process. Typically, the sawing process ends before the cut in the work piece has been fully completed. For example, patent application US 2007/0283944 A1 shows a method in which end portions of blocks are not cut. These end portions act as stabilizing support abutments for the wafers during sawing and subsequent removal and washing procedures.

After sawing, the wire is cut so that the work piece can be removed. Thereby, the wire web is destroyed and needs to be rebuilt before the next work piece can be sawed. This means that wire is wasted and that the productivity of the wire saw is reduced.

### SUMMARY

In view of the above, a wire saw work piece support device according to claim 1, a wire saw work piece support spacer according to claim 8, the uses thereof according to claims 16 and 17, a method according to claim 18, and a wire saw device according to claim 25 are provided. Further advantages, features, aspects and details are apparent from the dependent claims, the description and drawings.

According to one embodiment, a wire saw work piece support device is provided. The saw work piece support device has a support surface adapted for supporting a work piece being sawed by a wire saw during sawing, the support surface defining a support plane, which may be the plane at which the work piece is supported during sawing. The wire saw work piece support device includes: a solid support body; and at least one wire receiving volume for receiving therein a wire of the wire saw during sawing, the at least one wire receiving volume having a work piece side delimited by the support plane, and a base side delimited by a surface portion of the solid support body. The at least one wire receiving volume has a thickness between the work piece side and the base side of at least 60 mm, and in embodiments of more than 70 mm or even more than 80 mm, in a direction orthogonal to the support plane. A further embodiment is directed to the use of the above-described wire saw work piece support device for supporting a work piece in a wire saw device.

According to a further embodiment, a wire saw work piece support spacer is provided. The wire saw work piece support spacer is adapted for a wire saw work piece support device, e.g., one according to any one of the embodiments described herein. The wire saw work piece support spacer has a support surface adapted for supporting a work piece being sawed by a wire saw during sawing, the support surface defining a support plane, at which the work piece may be supported during sawing, and a base surface adapted for being supported by a solid support body of the wire saw work piece support device, and at least one wire receiving portion defining a respective wire receiving volume for receiving therein a wire of the wire saw having sawn through the work piece. The at least one wire receiving portion is arranged between the support surface and a portion of the base surface. The at least one wire receiving portion includes, and in embodiments is made of, a solid material sawable by the wire saw wire. The at least one wire receiving portion further has a thickness between the support surface and the base surface portion of at least 60 mm, and in embodiments of more than 70 mm or even more than 80 mm, in a direction orthogonal to the support plane. A further embodiment is directed to the use of the above-described wire saw work piece support spacer for supporting a work piece in a wire saw device.

According to a further embodiment, a method of sawing a work piece using a wire saw is provided. The wire saw has a work piece support device and a support spacer, e.g. according to any embodiment described herein. The method includes:

Providing a solid support body of the work piece support device, the solid support body having a spacer support surface;

Providing the support spacer, the support spacer having a work piece support surface, a base surface and at least one wire receiving portion defining a respective wire receiving volume for receiving therein a wire of the wire saw, the at least one wire receiving portion being arranged between the support surface and a portion of the base surface, wherein the at least one wire receiving portion includes a solid material sawable by the wire saw wire;

Placing the support spacer with its base surface onto the spacer support surface, so that the support spacer is supported by the solid support body;

Placing the work piece onto the work piece support surface of the support spacer, possibly before the placing of the support spacer onto the spacer support surface, so that as a result of the placing steps, irrespective of their order, the support spacer is sandwiched between the support body and the work piece; and

Sawing through at least a portion of the work piece by a sawing wire section of a wire of the wire saw, thereby creating a cut in the work piece, so that at least a part of the sawing wire section leaves the work piece from the cut and is received in the at least one wire receiving portion or volume;

sawing, by the part of the wire section received in the at least one wire receiving portion, into the solid material included in the at least one wire receiving portion, thereby creating a cut in the solid material; and

retracing the at least one sawing wire section through the cut in the solid material and optionally also through the cut in the work piece.

According to a further embodiment, a wire saw device, includes a wire saw work piece support device, a wire saw work piece support spacer, and a controller having a controller memory, the controller memory having stored thereon program code for performing a method of sawing a work piece using a wire saw. The method includes:

Providing a solid support body of the work piece support device, the solid support body having a spacer support surface;

Providing the support spacer, the support spacer having a work piece support surface, a base surface and at least one wire receiving portion defining a respective wire receiving volume for receiving therein a wire of the wire saw, the at least one wire receiving portion being arranged between the support surface and a portion of the base surface, wherein the at least one wire receiving portion includes a solid material sawable by the wire saw wire;

Placing the support spacer with its base surface onto the spacer support surface, so that the support spacer is supported by the solid support body;

Placing the work piece onto the work piece support surface of the support spacer, possibly before the placing of the support spacer onto the spacer support surface, so that as a result of the placing steps, irrespective of their order, the support spacer is sandwiched between the support body and the work piece; and

Sawing through at least a portion of the work piece by a sawing wire section of a wire of the wire saw, thereby creating a cut in the work piece, so that at least a part of the sawing wire section leaves the work piece from the cut and is received in the at least one wire receiving portion or volume;

sawing, by the part of the wire section received in the at least one wire receiving portion, into the solid material included in the at least one wire receiving portion, thereby creating a cut in the solid material; and

retracing the at least one sawing wire section through the cut in the solid material and optionally also through the cut in the work piece.

Embodiments are also directed at apparatuses for carrying out the disclosed methods and including apparatus parts for performing each described method step. These method steps may be performed by way of hardware components, a computer programmed by appropriate software, by any combination of the two or in any other manner. Furthermore, embodiments according to aspects of the invention are also directed at methods by which the described apparatus operates. It includes method steps for carrying out every function of the apparatus.

### BRIEF DESCRIPTION OF THE DRAWINGS

So that the manner in which the above recited features of aspects of the present invention can be understood in detail, a more particular description of aspects of the invention, briefly summarized above, may be had by reference to embodiments. The accompanying drawings relate to embodiments of the invention and are described in the following:

FIGS. 1 a to 1c illustrate sawing steps during the production of a silicon wafer;

FIG. 2 shows a schematic top view of a squarer;

FIG. 3 shows a perspective view of a work piece supported by a support body;

FIG. 4a shows a perspective view of a support device according to an embodiment of the invention; and FIG. 4b shows a side view of the support device of FIG. 4a.

FIG. 5 shows a perspective view of a support spacer according to an embodiment of the invention;

FIG. 6 shows a side view of a support device according to an embodiment of the invention including a spacer;

FIG. 7 shows a perspective view of an ingot being supported by a support device according to an embodiment of the invention;

FIG. 8 shows a side view of a support device according to a further embodiment of the invention including a spacer

FIGS. 9a to 9d illustrate steps of a method of sawing a work piece; and

FIG. 10 shows a cross-sectional side view of the method step of FIG. 9b seen from a different side than in FIG. 9b.

### DETAILED DESCRIPTION

Reference will now be made in detail to the various embodiments of the invention, one or more examples of which are illustrated in the figures. Within the following description of the drawings, the same reference numbers refer to same components. Generally, only the differences with respect to individual embodiments are described. Each example is provided by way of explanation of aspects of the invention and is not meant as a limitation of the invention. Further, features illustrated or described as part of one embodiment can be used on or in conjunction with other embodiments to yield yet a further embodiment. It is intended that the description includes such modifications and variations.

Furthermore, in the following description, a wire management unit will be understood as a device handling the supply of wire to a working area of a wire saw device, such as a cropper, a squarer, or a wafer cutting wire saw. Typically, the wire saw includes a wire guide for transporting and guiding the wire in a wire moving direction while the wire management unit provides control of the wire tension. Furthermore, the wire provided by the wire management unit forms a wire web as described above. In the following, a wire web will be considered as the web formed by a single wire management unit. It should be understood that a wire web may contain more than one working area which is defined as an area in which a sawing process is performed.

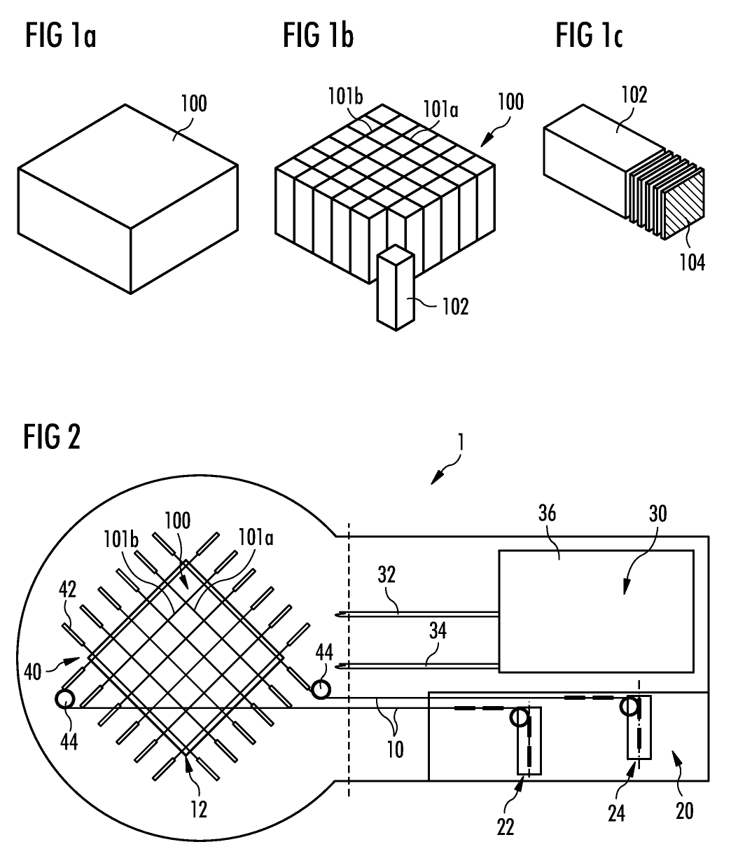

The basic sawing steps performed during the production of thin semiconductor wafers (such as multi-crystalline silicone wafers). FIG. 1a shows a silicon ingot 100 that is a work piece to be sawn. The silicon ingot 100 may be produced by casting in a crucible and then slow cooling, to ensure an appropriate crystalline form. Referring now to FIG. 1b, the ingot is cut by a squarer into a plurality of blocks 102. To this purpose, the squarer applies a plurality of first cuts 101a and a plurality of second cuts 101b to the ingot. The first cuts 101a are made by wires of a wire saw arranged in a first direction, and the second cuts 101b are made by wires of a wire saw arranged in a second direction perpendicular to the first direction. Both wires are moved relative to the work piece during cutting in a third direction (vertical direction in FIG. 1b), thereby creating the cuts 101a and 101b. Now referring to FIG. 1c, the blocks 102 are then sawn by a further wire saw into thin wafers 104 (as shown in FIG. 1c). The resultant wafers may be used to produce solar cells for the photovoltaic industry.

FIG. 2 shows a schematic top view of a wire saw device 1 being a squarer. While a squarer is particularly suited for carrying out aspects of the invention, the invention is not limited to the wire saw device being a squarer, but can instead also be used for other wire saw devices such as a cropper or the like. For example, a cropper wire web may be provided, e.g., as disclosed in European Patent Application No. 08154493.4, which is enclosed herein by reference, see, e.g., FIG. 1 thereof.

The wire saw device (squarer) 1 of FIG. 1 includes a wire management unit 20 with a first wire handling section 22 and a second wire handling section 24. Further, the wire saw device 1 has a working area 40, in which the wire 10 forms a wire web 12 in which the actual sawing process is performed.

The first wire handling section 22 and the second wire handling section 24 of the wire management unit 20 each have a wire spool and a plurality of pulleys for redirecting the wire 10 towards the wire web 12 in the working area 40. Further, in the working area 40, a plurality of pulleys 44 and wire guides 42 are arranged for guiding the wire such that the wire web 12 is created. In FIG. 2, a matrix-like wire web 12 of the squarer is shown with first sawing wire sections arranged in parallel in a first direction (for creating the cuts 101a) and with second sawing wire sections arranged in parallel in a second direction (for creating the cuts 101b), the second direction being perpendicular to the first direction. The wire web may have, for example, six first sawing wire sections and six second sawing wire sections. The first sawing wire sections are displaced relative to the second sawing wire sections in a sawing direction (perpendicular to the image plane of FIG. 2) so that the different sawing wire sections intersecting in the view of FIG. 2 do not interfere with each other. In the working area 40, a work piece support device is provided (not shown) for carrying the work piece 100 to be sawed. The work piece support device may be in accordance with any embodiment described herein, especially with the embodiment shown in FIGS. 4a and 4b.

Further, the wire management unit has a coolant system 30. The coolant system 30 includes a coolant tank 36 for storing coolant (generally slurry or water-based coolant), a coolant supply line 32 for supplying coolant from the coolant tank to the working area 40, and a coolant return line 34 for returning the coolant from the working area 40 to the coolant tank 36. The coolant supply line 32 has a plurality of nozzles for spraying the coolant onto the wire 10 within the wire web 12. The nozzles may be arranged along a square-shaped boundary of the wire web 12. While only one supply line 32 is shown, there may be more than one supply line, e.g., a supply line for each side of the square-shaped boundary of the wire web (i.e., a total of four supply lines), each supply line supplying coolant to a plurality of spray nozzles (e.g., six spray nozzles for each of the six wire sections per side of the wire web 12). In the case of diamond wire, slurry is not needed, but it is still advantageous to cool the diamond wire during cutting. In this case the slurry can be replaced by some other coolant, such as a water-based cooling liquid.

During a cutting process by means of the wire saw device 1, the wire 10 is provided from a spool of the first wire handling unit 22. During sawing, the wire 10 is unwound from the spool. Within the first wire handling unit 22, the wire 10 is guided from the spool to some pulleys. The wire 10 is then guided to a cutting area, in which the wire web 12 is formed by the plurality of pulleys 44 and wire guides 42. After sawing, the wire 10 is then guided from the cutting area 40 or wire web 12 to the second wire handling unit 24. Here, the wire is guided, by further pulleys, to a spool of the second wire handling unit 24, and is wound onto the spool.

In the cutting area 40, sawing wire sections of the wire 10 are provided. The sawing wire sections are understood as part of the wire web 12 at a location of the wire web (or of the wire saw) at which a cut in the work piece 100 is to be performed, e.g., cut 101a or 101b. Generally, the wire 10 is transported through the sawing wire section so that, at different moments, different actual wire material is present in the sawing wire section. The sawing wire section is defined by the location in the wire saw, and not by the specific material of the wire being transported therethrough. The work piece 100 is now sawed by moving the sawing wire sections of the wire 10 in a sawing direction relative to the work piece (100), i.e., either the work piece is moved towards and into the sawing wire sections, or the sawing wire sections are moved towards and into the work piece. This movement is generally in a direction perpendicular to the drawing plane of FIG. 2. Thereby, the cuts 101a, 101b in the work piece are created, as also indicated in FIG. 1b. The cuts 101a, 101b extend along the direction of the respective sawing wire section, and also in the sawing direction.

Due to the finite wire tension of the wire 10 in the wire web 12, the sawing wire sections do not form a perfectly straight line during sawing, but they rather form a bow, with the parts closer to a border of the work piece having cut more deeply through the work piece than the parts that are more in the interior of the work piece. FIG. 10 illustrates this bow of the wire 10, wherein the part 100b of a work piece 100 closer to the border has a deeper cut than the part 100a that is more in the interior of the work piece 100. The bow can have a different shape for each of the wire saw sections, depending on their relative tension. Therefore, a cut is completed at different times for different parts of a sawing wire section: First, the parts of the sawing wire section close to a border exit the work piece 100 after having cut though the work piece, and only thereafter the parts of the sawing wire section that are more in the interior of the work piece exit the work piece 100 after having cut though the work piece.

Further, it has been found useful to displace first sawing wire sections (i.e., the parallel wire sections performing the cuts 101a in FIG. 2) of the wire 10 forming the wire web 12 relative to second sawing wire sections (i.e., the parallel wire sections performing the cuts 101a in FIG. 2) in a sawing direction (perpendicular to the image plane of FIG. 2). The displacement helps avoiding interference between the different sawing wire sections at the points of intersection in the view of FIG. 2. As a consequence, the tendency of different parts of the wire finishing the cutting at different times is further increased.

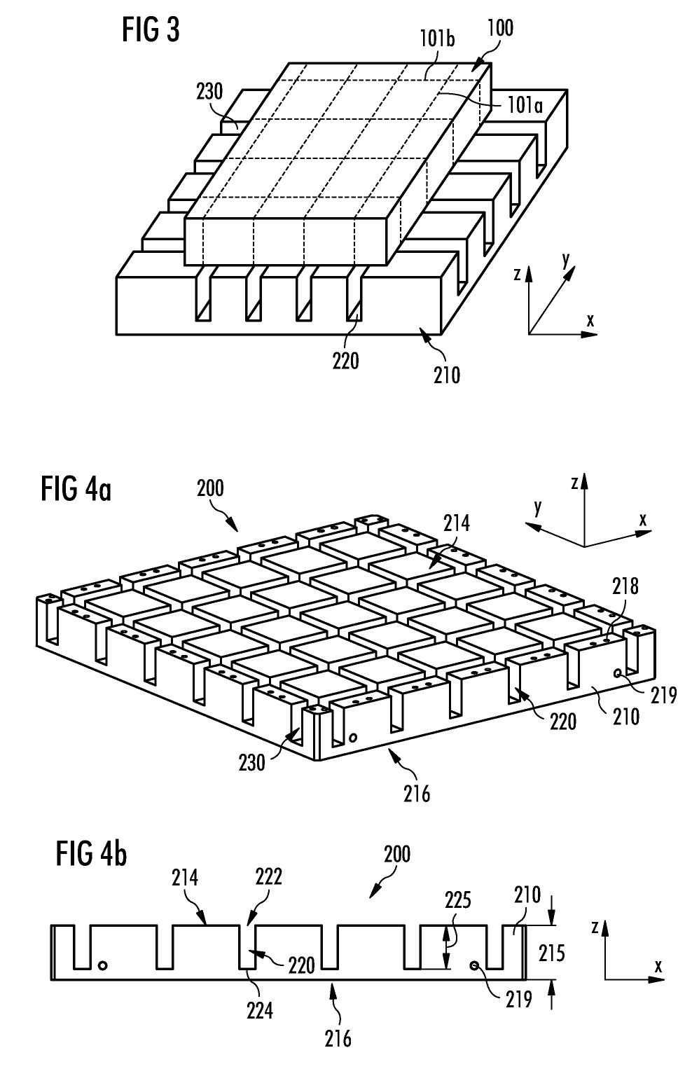

Aspects of the invention allow the wire 10 to fully cut through the work piece. Cutting fully through the work piece allows using also an end of the work piece which previously could not be used in the subsequent processing steps, hence increasing productivity. To this purpose, referring to FIG. 3, the work piece 100 is supported by a wire saw work piece support device 200 according to an embodiment of the invention. A similar wire saw work piece support device 200, without a work piece, is also shown in FIGS. 4a and 4b. The following description relates to both FIG. 3 and FIGS. 4a, 4b.

The wire saw work piece support device 200 includes a solid support body 210. The support body 210 is made of a material that is so hard that it is not adapted for being sawed by the wire saw during normal sawing. Thus, the support body 210 is made of, e.g., metal. The upper surface of the support body 210 is a support surface 214 on which the work piece 100 can be supported during sawing, as shown in FIG. 3. The support surface 214 defines a support plane, i.e., the plane at which the work piece 100 is supported in FIG. 3.

Further, the solid support body 210 has four first grooves 220 and four second grooves 230 formed therein. The first grooves 220 extend in a first direction parallel to the support plane, and the second grooves 230 extend in a second direction along the support plane orthogonal to the first direction. The first and second grooves extend, each, from one respective end of the support surface to the respective opposite end of the support surface. The first grooves 220 are parallel to each other; and also the second grooves 230 are parallel to each other.

The grooves 220, 230 define respective wire receiving volumes (also designated with reference signs 220, 230), in which the wire 10 of the wire saw 1 can be received during sawing. Thus, the at least one wire receiving volume 220, 230 includes the interior of the respective first or second grooves. Due to the presence of the wire receiving volumes, even if the wire is not straight but forms a bow due to its finite tension, the wire is enabled to cut completely through the work piece 100, because the parts of the sawing wire section having completed the cut can be received in the wire receiving volumes of the grooves 220, 230. To this purpose, the grooves 230, 240 are aligned with the respective sawing wire sections performing the cuts, e.g., the cuts 101a, 101b (also shown in FIG. 2).

The wire receiving volumes of the grooves 220, 230 are the volumes between the support plane (defining work piece sides of the respective wire receiving volumes) and the bottom of the grooves 224 (defining base sides of the respective wire receiving volumes). The grooves 220, 230 have a depth (i.e., a thickness of the wire receiving volume between the work piece side and the base side) of at least 60 mm in a direction orthogonal to the support plane (vertical direction in FIGS. 3 and 4). This allows complete sawing through the work piece, even when the wires are displaced by, e.g., 30 mm and when the difference between different parts of a sawing wire portion due to the bow in the sawing wire portion is up to 25 mm. 25 mm is much more than the typical differences encountered in present wire saws. However, it is anticipated that such values as large as 25 mm may be present in novel wire saws allowing or requiring less wire tension, especially wire saws using diamond-coated wire. The total displacement between different parts of different sawing wire portions may be the sum of the values given above, i.e., with the above values up to 55 mm. The depth of the grooves of 60 mm allows the wire sawing through a work piece even in this situation.

Referring to FIG. 4a, more aspects of the support device 200 are described. Each of these elements can be included in any other embodiment described herein. As a first aspect, the support body 210 further includes a plurality of fixation elements 218 on the border of its support surface. The fixation elements 218 are formed as openings into which fixation pins may be inserted (not shown). The fixation elements allow a work piece to be held after the wire saw has sawed therethrough completely. Thus, due to the fixation elements, a reliable support of the work piece is achieved even when the work piece has been fully cut through. It is advantageous, but not necessary, that at least one fixation element is provided at each side of the support surface between two neighboring wire receiving volumes, or grooves. While the fixation elements have been shown as openings (for pins), other fixation elements such as a pin, a wall portion, or a step-shaped frame may be provided.

As a further aspect, gripper openings 219 are provided on opposing side faces of the support body 210. The gripper openings 219 allow a gripper to grip the support structure, thus enabling easier transport of the work piece supported by the gripper. Hence, as a further aspect, the support device 200 is removable from the wire saw device. As a further aspect, openings in a bottom side 216 (the side of the support body 210 opposite to the support plane, not shown) allow an easy and reliable alignment of the support device 200 in the wire saw device.

As a further aspect, the first grooves are spaced from one another at a fixed distance (center-to-center). The distance here is between 100 mm and 200 mm, more specifically between and 140 mm and 170 mm, and specifically about 156 mm (with a tolerance of about 1 to 5 mm). Similarly, as a further aspect, the second grooves are spaced from one another at a fixed distance (center-to-center). The distance here is also between 100 mm and 200 mm, more specifically between and 140 mm and 170 mm, and specifically about 156 mm (with a tolerance of about 1 to 5 mm). The total extension of the support body 210 along the support plane may be 900 mm in a first direction (along the first grooves 220), and also 900 mm in a second direction (along the second grooves 230). The outermost grooves 220 and/or 230 may be arranged at a distance from the border of the support body. This distance may be between 20 mm and 60 mm, especially between 40 mm and 50 mm, especially about 43 mm (with a tolerance of about 1 to 5 mm).

With reference to FIG. 4b, some further dimensions of the support body 210 and the grooves, or wire receiving volumes 220, 230 are illustrated. Here, the total thickness 215 of the support body in a direction orthogonal to the work piece support plane is 100 mm.

Further, the depth of the grooves, or wire receiving volumes 220, 230 (between the work piece side 222 delimited by the support plane, and the base side 224 delimited by a surface portion of the solid support body 210, i.e., the bottom of the groove) is 80 mm. Thus, the distance between the base side 224 and the bottom side 216 of the support body is 20 mm. As a general aspect, the distance between the base side 224 and the bottom side 216 of the support body is smaller than the thickness between the work piece side and the base side of the wire receiving volume. The length of grooves is generally, as is also shown in FIG. 4a, from one end of the support surface 214 to an opposite end of the support surface 214. The width may be between 15 mm and 30 mm, e.g., 21 mm.

In the following, some possible variations of the support body 210 of FIGS. 3, 4a, and 4b are described. The wire receiving volume has been described as a groove, but can in fact have an arbitrary shape as long as it is adapted to receive a sawing wire section of the wire saw device (e.g., the shape of the recess 220 shown in FIG. 8). Generally, the wire receiving volume 220, 230 may be formed as a recess in the support body 210. Further, only one wire receiving volume may be provided. However, generally a plurality of wire receiving volumes will be provided, especially a plurality of first and second grooves, corresponding to a plurality of sawing wire sections. Especially, for the squarer shown in FIG. 2, six first wire receiving volumes and six second wire receiving volumes may be provided.

Further, generally the first and/or second grooves may have a depth of at least 60 mm, of at least 70 mm, or even of at least 80 mm in a direction orthogonal to the support plane.

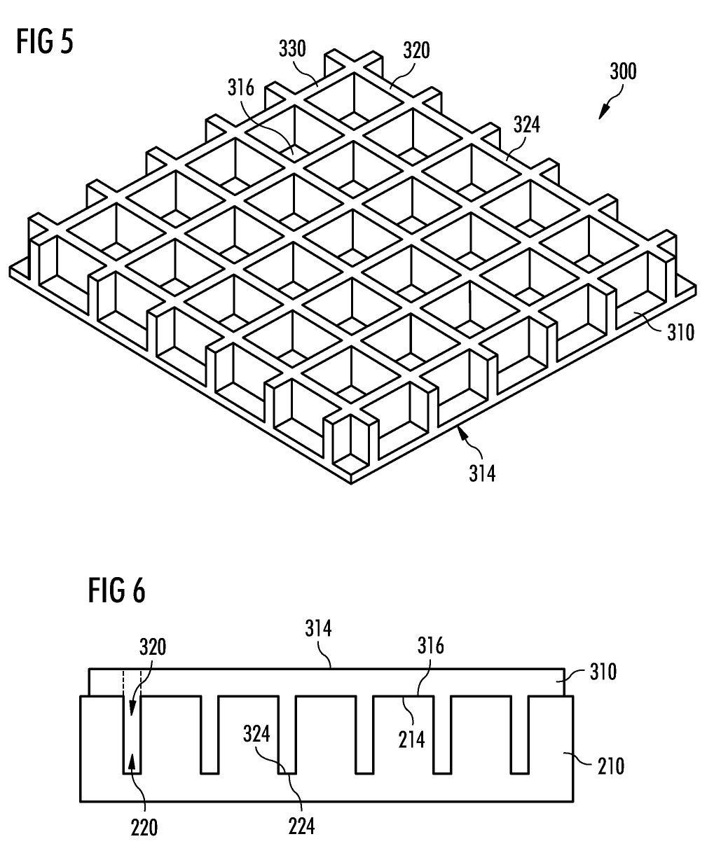

FIG. 5 shows a perspective view of a support spacer 300 according to an embodiment of the invention. The support spacer has a spacer body 310 with a base surface 316 adapted for being supported by the support body 210 of the wire saw work piece support device 200 shown in FIGS. 4a and 4b. More precisely, the base surface 316 has a profile which is form-fit to, i.e., matching, the support surface 214 of the support body 210. Hence, the support spacer body 310 can be placed onto the support body 210 of FIGS. 4a and 4b to form an enhanced compound support device as shown in FIG. 6. Hence, the support spacer 300 and the support device are inter-related products.

Referring to FIGS. 5 and 6, further elements of the wire saw work piece support spacer are described. The wire saw work piece support spacer has a support surface 314 for supporting the work piece 100 during sawing by the wire saw device. The support surface 314 defining a support plane, i.e., the plane at which the work piece is supported during sawing.

Further, the base surface 316 of the spacer body 310 has first protrusions 320 extending longitudinally and in parallel to each other in a first direction along the base surface 316, and second protrusions 330 extending longitudinally and in parallel to each other in a second direction along the base surface, the second direction being orthogonal to the first direction. The second protrusions 330 intersect the first protrusions 320 such as to form a web of protrusions. The protrusions 320 and 330 match the corresponding grooves 220 and 230 of the support body 210.

The protrusions 320, 330 include, or are even made of, a solid material sawable by the wire saw wire 10. Thus, as can be seen in FIG. 6, the protrusions 320 and 330 are wire receiving portions. The wire receiving portions 320, 330 are arranged between the support surface 314 and a portion 324 of the base surface 316, and define respective wire receiving volumes (namely, the volume between the support surface 314 and a portion 324 of the base surface 316) for receiving therein the wire 10 of the wire saw 1, after the wire has sawn through the work piece 100.

According to an embodiment, the height of the protrusions from the surface 316 to surface portion 324 is 60 mm (and hence the depth of the grooves 220 from the surface 214 to surface portion 224 is also 60 mm), and the total height of the support spacer body 310, from the surface 314 to surface portion 324 is 60 mm. Accordingly, the protrusions 320, 330 have a thickness between the support surface 314 and the base surface portion 324 of 70 mm in a direction orthogonal to the support plane. According to other embodiments, the thickness between the support surface 314 and the base surface portion 324 may be at least 60 mm (e.g., 50 mm for the protrusions plus 10 mm), at least 70 mm, or even at least 80 mm. The length of protrusions is generally, as is also shown in FIG. 4a, from one end of the spacer body 310 to an opposite end of the spacer body 310. The width may be between 15 mm and 30 mm, e.g., 21 mm (corresponding to the width of the dimensions of the recessions, e.g., grooves, in the support body 210). Further, as can be seen, the spacer body 310 also includes a joining portion (the flat portion including the support surface 314) joining the protrusions 320, 330 to each other. Due to the joining portion, the support surface 314 is a planar contiguous surface that defines the work piece support plane.

The sawable material of the protrusions 320, 330 can be, e.g., a resin such as polyurethane (possibly further including additives and/or filler material or filler space). As a general aspect, the support spacer including the protrusions 320, 330 is made as a single-piece unit, i.e., made integrally of one single piece.

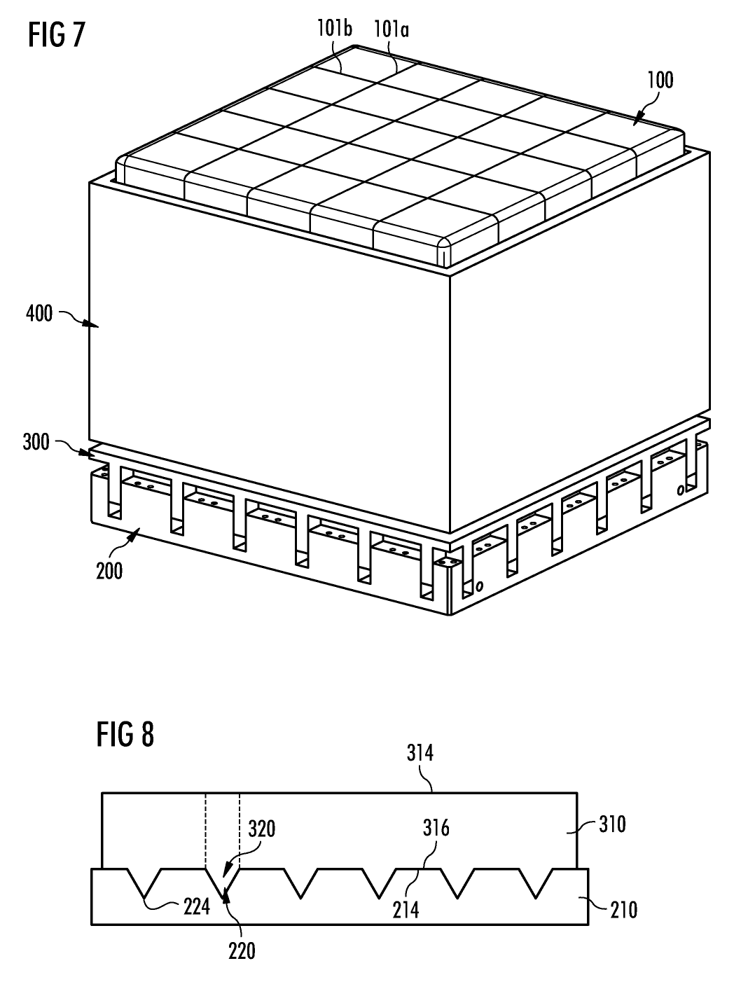

FIG. 7 shows, in an exploded perspective view, an arrangement, in which a work piece (ingot) 100 is supported by a support device 200 including a support spacer 300. The support device 200 is the same or similar to the support device 200 shown in FIGS. 4a and 4. The support spacer 300 is placed on the support device 200 as shown in FIG. 6. Further, the work piece 100 is placed on the support surface 314 (see FIG. 6) of the support spacer 300. Thus, during sawing of the work piece 100, the work piece support spacer 300 is sandwiched between the work piece support 200 and the work piece 100. Further, the intended first cuts 101a and second cuts 101b are shown on the upper face of the ingot or work piece 100. These first cuts 101a and second cuts 101b are in alignment with the wire receiving volumes defined by the support device 200 and the support spacer 300.

Further, a protection cover 400 is wrapped around side faces of the work piece 100. The protection cover 400 enhances further the stability of the work piece 100 even after sawing and reduces the risk of damage of the work piece. Further, the risk of the wire 10 leaving the material to be sawed is reduced even if the work piece should be irregularly shaped or slightly misaligned. Further, the protection cover 400 may cooperate with the fixation elements 218 (see FIG. 4a) for fixating the work piece after sawing, without damaging the work piece 100 itself.

As can be seen in FIGS. 6 and 7, the support spacer 300 allows the work piece to be supported at a sufficient distance from the base surface portion 324 (i.e., from the bottom of the grooves 320) such that there is enough wire receiving volume for allowing the wire 10 of the wire saw 1 to cut entirely through the work piece, even if the grooves 220, 230 alone would not provide sufficient depth.

As a further advantage, the sawable material of the protrusions may damp vibrations of the wire 10, which would otherwise occur if the wire was in free space. Due to the damped vibrations, the sawing operation is performed more smoothly. Especially the cut at the end of the work piece supported by the support surface 314 is improved by the damping of the vibrations.

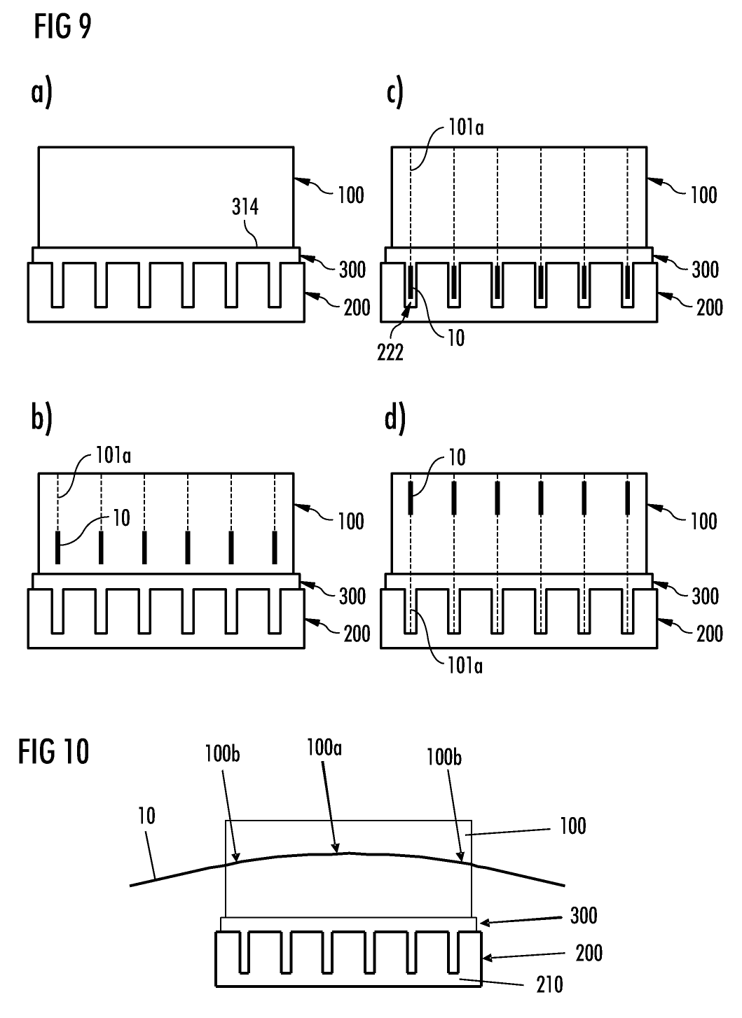

A further advantage is that, due to the support spacer, a method of sawing is enabled which includes retracing a sawing wire section of the wire 10, as is described in more detail with reference to FIG. 9.

A possible variation of the embodiment of FIG. 6 is shown in FIG. 8. Herein, generally the description of FIG. 6 applies. However, while the support body 210 of FIG. 6 has deep grooves 220 having a rectangular cross-section, the support body 210 of FIG. 7 has instead shallower grooves having a triangular cross-section. The protrusions 320 of the support spacer body 310 are modified accordingly, and now also have a triangular cross-section. Nevertheless, the dimensions in the embodiment of FIG. 8 are also chosen such that respective wire receiving volumes are defined by respective wire receiving portions (portions above the grooves 220, arranged between the support surface 314 and the bottom 324 of the grooves, such that the wire receiving portions 320 have a thickness between the support surface 314 and the bottom of the grooves 324 of at least 60 mm. Further embodiments have, again, differently profiled base surfaces 316. Generally, a profile 316 of the base surface allows easy alignment of the support body 210 and the support spacer 310, and allows reducing support spacer material which one may need to replace after each cut.

As further variation, there may be provided any number of wire receiving portions, e.g., only one wire receiving portion. Generally, according to an embodiment, there is provided a plurality of wire receiving portions, e.g., two times six wire receiving portions as shown in FIG. 5.

FIGS. 9a to 9d illustrate steps of a method of sawing a work piece according to a further embodiment. This method is enabled by the work piece support device and by the support spacer described above. As shown in FIG. 9a, a work piece 100, a work piece support device 200 and a support spacer 300 are provided. The work piece support device 200 has a solid support body 210 having a spacer support surface 214 as shown in FIG. 6. Further, the support spacer 300 has a work piece support surface 314, a base surface 316 and protrusions 320, i.e., wire receiving portions defining respective wire receiving volumes, as shown in FIG. 6. Further, additional protrusions 330 extending in a direction perpendicular to the direction of the protrusion 320 may be provided as shown in FIG. 5.

The protrusions 320, 330 include a solid material sawable by the wire saw wire 10, such as polyurethane. As described above with reference to FIGS. 5 to 8, the protrusions 320, 330 are arranged between the support surface 314 and a portion 324 of the base surface 316 and define respective wire receiving volumes for receiving therein a wire of the wire saw.

As shown in FIG. 9a, the support spacer 300 is sandwiched between the support body 210 and the work piece 100 to be sawed. This arrangement is obtained as follows: The support spacer 300 is placed with its base surface (i.e., the profiled lower surface of the support spacer 300 surface in FIG. 9a) onto the spacer support surface (i.e., the profiled upper surface) of the support device 200), so that the support spacer 300 is supported by the solid support body 210; and the work piece 100 is placed onto the work piece support surface 314 of the support spacer 300. The order of these steps may be chosen arbitrarily, so the work piece 100 may be placed onto the work piece support surface 314 of the support spacer 300 before the placing of the support spacer 300 onto the spacer support surface.

Then, as shown in FIG. 9b, a sawing wire section of a wire 10 of the wire saw is introduced into the work piece 100 from above and moved, relative to the work piece 100, in a downward direction (sawing direction). Thereby, a cut 101a is created in the work piece 100 by the sawing wire section of the wire 10. Here, the wire section of the wire 10 is generally directed in the direction perpendicular to the drawing plane of FIG. 9b and cuts downwardly, so that the cut 101a extends in a vertical plane (i.e., in the sawing direction) and perpendicular to the drawing plane of FIG. 9b, as illustrated by the dashed lines of the cut 101a.

As described above, the sawing wire sections are not straight lines due to the finite tension of the wire 10, but rather form a bow. This bow is illustrated in FIG. 10. FIG. 10 shows the situation of FIG. 9b in a cross sectional side view from a different side, at a right angle from the side of the side view of FIG. 9b. Thus, the grooves seen in FIG. 10 are different grooves from the grooves seen in FIG. 9b. For example, if FIG. 9b shows the grooves 220 of FIG. 4a, then FIG. 10 shows the grooves 230 of FIG. 4a. Alternatively, if the support body 210 only has grooves in one direction, then no grooves may be visible in the cross-sectional view of FIG. 10.

In FIG. 10, it can be seen that the wire 10 cuts different portions of the work piece 100 at different depths. In particular, due to the bow, the wire 10 cuts less deeply into a central portion 100a of the work piece 100 than into a border portion 100b of the work piece 100. It can be advantageous to cut at lower wire tension than usual, especially for diamond wire. In this situation, the depth of the cut at the different portions 100a, 100b of the work piece (and, correspondingly, at the different portions of the cutting wire section) may be as large as 20 mm or even 25 mm or 30 mm. This variation in depth is visualized in FIG. 9b by the range of the thick line representing the wire 10.

In FIG. 9b, the sawing wire section of the wire 10 has not yet sawn through the work piece 100. When the downward movement of the wire 10 is continued relative to the work piece, eventually at least a part of the sawing wire section of the wire 10 (lower part of the thick line representing the wire 10) leaves the work piece 100 from the cut 101a and is received in the support spacer 300 (more precisely, in the wire receiving portion or volume of the support spacer 300). Because the wire receiving portion or volume of the support spacer 300 is directly adjacent to the work piece 100, the portion of the sawing wire section of wire 10 cuts into the wire receiving portion or volume directly after having left the work piece 100. The part of the wire section of wire 10 received in the wire receiving portion then saws into the solid material of the support spacer 300 (more precisely, the material of the wire receiving portion 320), thereby creating a cut in the solid material.

FIG. 9c shows the situation in which the wire 10 has been moved so far downward that it has cut completely through the work piece 100, so that the entire sawing wire section of the wire 10 has left the work piece 100 from the cut 101a in the sawing direction after having performed a cut through the work piece. Consequently, the entire sawing wire section of the wire 10 has been received in the support spacer 300, in the groove 220. The entire sawing section of the wire 10 thereby cuts into the wire receiving portion of the support spacer 300, in the sawing direction. Because the wire receiving portion or volume of the support spacer 300 is directly adjacent to the work piece 100, the portion of the sawing wire section of the wire 10 cuts into the wire receiving portion of the support spacer 300 directly after having left the work piece 100. Thus, the cut 101a is fully completed.

Then, as shown in FIG. 9d, the sawing wire section of the wire 10 retraces its previous path back through the cut in the solid material of the support spacer 300, by moving the wire 10 in a wire releasing direction opposite to the sawing direction relative to the work piece 100. Then, the sawing wire section of the wire 10 is also moved through the cut 101a in the work piece 100. The sawing wire section of the wire 10 is then removed from the work piece 100 through the cut 101a, from the upper side, i.e., the side of the cut 101a at which the sawing wire section began cutting the work piece.

This method allows removing the work piece 100 from the wire saw after having performed a cut, without destroying the wire web, and especially after fully cutting through the work piece 100. Previously, removal of the work piece 100 generally required the destruction of the wire web. Retracing of the wire as described herein was difficult because when the wire has left a cut in the work piece, it is difficult to retrace the cut. According to the method described herein, the retracing has become possible because the cut is extended into material of the support spacer. Due to the retracing, a destruction of the wire web can be avoided.

In FIGS. 9a to 9d, a situation is shown in which the cut is performed by six cutting wire sections in parallel. Generally, these sawing wire section form a wire web in the wire saw device, as illustrated in FIG. 2 (wire web 12). The six sawing wire sections of FIGS. 9a to 9d extend in parallel to each other, in a direction orthogonal to the drawing plane essentially perpendicular to the sawing direction (i.e., neglecting, e.g., the bow of the wire and other tolerances generally being less than 5°). These six sawing wire sections are in the following also referred to as first sawing wire sections.

In addition to the first sawing wire sections, second sawing wire sections are provided (not shown in FIGS. 9a to 9d, but described above, e.g., with reference to FIG. 2). The second sawing wire sections extend in parallel to each other, in a direction parallel to the drawing plane of FIGS. 9a to 9d, i.e., in a direction essentially perpendicular to the first direction and to the sawing direction. In FIGS. 9a to 9d, the arrangement of the second sawing wire sections are like the arrangement of the sawing section of wire 10 in FIG. 10. As described above, the first sawing wire sections are vertically displaced relative to second sawing wire sections, i.e., displaced in the sawing direction. The displacement helps avoiding interference between the first and second sawing wire sections. Otherwise, the above description of the first wire sections also applies to the second wire sections.

In the above description, the support device 200 and the support spacer are according to the embodiment of FIG. 6. So, in particular, the wire receiving volume has a thickness of at least 60 mm, and may even have a thickness of at least 70 mm or even of at least 80 mm. Further, the wire receiving portion of the support spacer 300 includes a resin, i.e., the solid material of the wire receiving portion includes a resin or is a resin. Alternatively or additionally, other variations of the above embodiment may be used. For example, the method described with reference to FIGS. 9a to 9d may be performed using any support device and any support spacer described herein. So, for example, the method may be performed using only the first sawing sections, and with no second sawing sections. Any number of sawing sections may be used, and the method is even applicable when there is only one sawing section.

As a further variation of the method, the wire could be retraced only through the solid material of the support spacer 300, and not necessarily through the cut 101a in the work piece 100. For example, the work piece 100 may be removed from the wire saw before retracing the wire.

In the following, some general aspects of the embodiments described herein will be summarized. Each of these general aspects can be combined with any other general aspect, within any embodiment described herein, to generate yet another embodiment.

According to an aspect, a wire saw device and/or portions thereof such as the wire handling portions or the working area can be adapted for diamond wire, and methods of operating can be performed with diamond wire. This can, for example, be done by adapting the groove structure of pulleys and guiding elements with an appropriate pitch of grooves, a different depth of grooves and/or a different shape of grooves than for conventional such elements. Thereby, typically the cutting speed can be increased, e.g., by a factor of 2, the energy consumption of the wire saw device can be reduced and, further, as yet another example, the costs of squaring silicon ingots or wafering silicon can be significantly reduced.

According to an aspect, a wire saw work piece support device has a support surface adapted for supporting a work piece being sawed by a wire saw during sawing, the support surface defining a support plane at which the work piece is supported during sawing. The wire saw work piece support device includes: a solid support body; and at least one wire receiving volume for receiving therein a wire of the wire saw during sawing, the at least one wire receiving volume having a work piece side delimited by the support plane, and a base side delimited by a surface portion of the solid support body, wherein the at least one wire receiving volume has a thickness between the work piece side and the base side of at least 60 mm, and according to further aspects of at least 70 mm or of at least 80 mm, in a direction orthogonal to the support plane. According to a further aspect, the support body is adapted for not being sawed by the wire saw during normal sawing. Thus, the support body may have a resistance against sawing that is larger than the resistance supported by a normal wire saw. For example, metal generally has such a large resistance. Hence, according to a further aspect, the support body includes metal or is even made of metal. According to a further aspect, the at least one wire receiving volume extends in parallel to the support plane from a first end of the support body or support surface to an opposite second end of the support body or support surface.

According to a further aspect, the solid support body has at least one first groove formed therein, the at least one first groove extending in a first direction parallel to the support plane, such that the respective base side of the at least one wire receiving volume is located at the bottom of a respective one of the at least one first groove. Thus, the at least one wire receiving volume includes the interior of the first grooves. According to a further aspect, the at least one wire receiving volume further includes at least one second groove formed in the solid support body, wherein the at least one second groove extends in a second direction along the support plane orthogonal to the first direction. Thus, the at least one wire receiving volume includes the interior of the second groove(s). The first groove(s) and/or the second groove(s) may have a depth of at least 60 mm, of at least 70 mm, or of at least 80 mm in a direction orthogonal to the support plane. The first groove(s) and/or the second groove(s) may extend from a respective end of the support surface to a respective opposite end of the support surface.

According to a further aspect, the at least one wire receiving volume is a plurality of wire receiving volumes, and according to a further aspect includes a plurality of first and/or second grooves, e.g., six first grooves and/or six second grooves. The first grooves may be parallel to each other; and also the second grooves may be parallel to each other. The second grooves may be perpendicular to the first groove(s).

According to a further aspect, the wire saw work piece support device further includes a wire saw work piece support spacer including, or made of, a solid material sawable by the wire saw wire, the wire saw work piece support spacer having at least one wire receiving portion filling the at least one wire receiving volume at least partially. Thus, the at least one wire receiving portion may define the at least one wire receiving volume, and according to a further aspect fills the at least one wire receiving volume completely.

According to a further aspect, the solid material is more easily sawable than the work piece support body, and according to a further aspect is more easily sawable than the work piece. Here, more easily sawable means that the material has less resistance against the sawing, so that under the same conditions a faster cut can be provided in the material. Generally, this means that the material is softer.

According to a further aspect, the support spacer includes or is even made of a resin. The resin may include or be polyurethane, possibly also including additives and other filler material and/or open spaces. The additives may be hardening additives reducing the elasticity of the polyurethane.

According to a further aspect, the wire saw work piece support spacer has a first spacer surface being the support surface; and a second spacer surface opposite the first spacer surface, the second spacer surface being form-fit to a surface profile of the solid support body and optionally even contacting the surface portion. According to this aspect, during sawing of the work piece, the work piece support spacer is sandwiched between the work piece support body and the work piece.

According to a further aspect, the first spacer surface may be flat and contiguous, i.e., a connected surface, or even a simply connected surface, i.e., without holes. According to a further aspect, the support surface is formed as a surface of the support body, and the at least one wire receiving volume is formed as a recess in the support body.

According to a further aspect, the work piece is a semiconductor work piece. For example, in a particularly useful aspect, the wire saw device is a squarer, and the wire saw work piece is an ingot to be sawed by the squarer. According to a further aspect, the wire saw device is a diamond wire saw device and the wire is diamond wire, i.e. wire coated with diamond particles.

According to a further aspect, a wire saw work piece support spacer adapted for a wire saw work piece support device is provided. The wire saw work piece support spacer may be in accordance to any one of the respective claims, or any other description herein. The wire saw work piece support spacer has a support surface adapted for supporting a work piece being sawed by a wire saw during sawing, the support surface defining a support plane at which the work piece is supported during sawing; and a base surface adapted for being supported by a solid support body of the wire saw work piece support device, and at least one wire receiving portion defining a respective wire receiving volume for receiving therein a wire of the wire saw having sawn through the work piece, the at least one wire receiving portion being arranged between the support surface and a portion of the base surface. The at least one wire receiving portion includes, and according to a further aspect is made of, a solid material sawable by the wire saw wire. The at least one wire receiving portion has a thickness between the support surface and the base surface portion of at least 60 mm, of at least 70 mm, or of at least 80 mm in a direction orthogonal to the support plane. Thus, during sawing of the work piece, the work piece support spacer is sandwiched between the work piece support body and the work piece.

According to a further aspect, the base surface is profiled. According to a further aspect, the profile is form-fit to the surface of a solid support body according to any embodiment described herein, especially form-fit to the surface of a solid support body having at least one groove.

According to a further aspect, the at least one wire receiving portion is a plurality of wire receiving portions. According to a further aspect, the wire receiving portions include first protrusions extending longitudinally and in parallel to each other in a first direction along the base surface. According to a further aspect, the length of the protrusion(s) is from a first end of the support surface or of the support body to a second end of the support surface or of the support body opposite the first end. According to a further aspect, the width of the protrusion(s) is between 15 mm and 25 mm, e.g. 21 mm. According to a further aspect, the height of the protrusion(s) is at least 50 mm, at least 60 or 70 or 80 mm, and/or not more than 100 mm. According to a further aspect, the wire receiving portions further include second protrusions extending longitudinally and in parallel to each other in a second direction along the base surface and intersecting the first protrusions such as to form a web of protrusions, the second direction being orthogonal to the first direction.

According to a further aspect, the support spacer further includes a joining portion joining the wire receiving portions to each other. According to a further aspect, the support spacer or the joining portion has a planar contiguous surface that defines the work piece support plane. According to a further aspect, the wire saw work piece support spacer is a single-piece unit. According to a further aspect, wherein the lower surface is form-fit to the shape of a corresponding surface of the support body of a wire saw work piece support device according to any embodiment described or claimed herein.

A further aspect is related to the use of a wire saw work piece support device according to any embodiment described or claimed herein for supporting a work piece in a wire saw device. A further aspect is related to the use of a wire saw work piece support spacer according to any embodiment described or claimed herein for supporting a work piece in a wire saw device. According to a further aspect, the wire saw device is a diamond wire saw device and the wire is diamond wire.

According to a further aspect, a method of sawing a work piece using a wire saw having a work piece support device and a support spacer is provided. The work piece support device and/or the support spacer may be in accordance to any embodiment described or claimed herein. The method includes: providing a solid support body of the work piece support device, the solid support body having a spacer support surface; providing the support spacer, the support spacer having a work piece support surface, a base surface and at least one wire receiving portion defining a respective wire receiving volume for receiving therein a wire of the wire saw, the at least one wire receiving portion being arranged between the support surface and a portion of the base surface, wherein the at least one wire receiving portion includes a solid material sawable by the wire saw wire; placing the support spacer with its base surface onto the spacer support surface, so that the support spacer is supported by the solid support body; placing the work piece onto the work piece support surface of the support spacer [possibly before the placing of the support spacer onto the spacer support surface], so that [as a result of the placing steps, irrespective of their order] the support spacer is sandwiched between the support body and the work piece; and sawing through at least a portion of the work piece by a sawing wire section of a wire of the wire saw, thereby creating a cut in the work piece, so that at least a part of the sawing wire section leaves the work piece from the cut and is received in the at least one wire receiving portion; sawing, by the part of the wire section received in the at least one wire receiving portion, into the solid material included in the at least one wire receiving portion, thereby creating a cut in the solid material; and retracing the at least one sawing wire section through the cut in the solid material, and optionally also through the cut in the work piece.

According to a further aspect, the at least one wire receiving volume has a thickness of at least 60 mm or at least 70 mm or at least 80 mm. According to a further aspect, the method further includes removing the sawing wire section from the work piece through the cut therein, especially from the side at which the sawing wire section was cutting when the cut in the work piece was started. According to a further aspect, during the sawing the at least one sawing wire section of the wire is moved in a sawing direction relative to the work piece, so that the cut extends in the sawing direction. Then, during retracing, the wire is moved in a wire releasing direction opposite to the sawing direction. According to a further aspect, the sawing in the at least one wire receiving portion (320, 330) is in the sawing direction, and according to a further aspect the portion of the sawing wire section cuts into the at least one wire receiving portion directly after having left the work piece. According to a further aspect, the sawing further includes cutting, by a sawing wire section of the wire, through the work piece so that the sawing wire section leaves the work piece entirely in the sawing direction after having performed a cut through the work piece, and cutting, by the entire sawing wire section, into at least one wire receiving portion of the support spacer, wherein in embodiments the cutting is in the sawing direction, and wherein in embodiments the portion of the sawing wire section cuts into the at least one wire receiving portion directly after having left the work piece. According to a further aspect, the wire receiving portion includes a resin, and according to a further aspect the solid material includes a resin or is a resin.

According to a further aspect, the at least one sawing wire section is a plurality of sawing wire sections forming a wire web, and wherein the sawing wire sections include first sawing wire sections extending in a first direction parallel to each other, the first direction being essentially perpendicular to the sawing direction. According to a further aspect, the sawing wire sections further include second sawing wire sections extending in a second direction parallel to each other, the second direction being essentially perpendicular to the first direction and to the sawing direction. According to a further aspect, the support device and/or the support spacer have any other features described or claimed herein. Especially, the work piece support device may be in accordance with any one of claims 1 to 7; and/or the work piece support spacer may be in accordance with any one of claims 8 to 15. According to a further aspect, the method is carries out in a diamond wire saw device, with diamond wire.

According to a further aspect, a wire saw device is provided, the wire saw device including a wire saw work piece support device, e.g., any such support device described or claimed herein; a wire saw work piece support spacer, e.g., any such support spacer described or claimed herein; and a controller having a controller memory, the controller memory having stored thereon program code for performing any method described or claimed herein, e.g., the method according to any one of claims 18 to 24. According to a further aspect, the wire saw device is a diamond wire saw device and the wire is diamond wire.

While the foregoing is directed to embodiments of the invention, other and further embodiments of the invention may be devised without departing from the basic scope thereof, and the scope thereof is determined by the claims that follow.

1.-25. (canceled)

26. A wire saw work piece support device having a support surface adapted for supporting a work piece being sawed by a wire saw during sawing, the support surface defining a support plane; the wire saw work piece support device comprising:
a solid support body; and
at least one wire receiving volume for receiving therein a wire of the wire saw during sawing, the at least one wire receiving volume having a work piece side delimited by the support plane, and a base side delimited by a surface portion of the solid support body, wherein the at least one wire receiving volume has a thickness between the work piece side and the base side of at least 60 mm in a direction orthogonal to the support plane.

27. The wire saw work piece support device according to claim 26, wherein the solid support body has at least one first groove formed therein, the at least one first groove extending in a first direction parallel to the support plane, such that the respective base side of the at least one wire receiving volume is located at the bottom of a respective one of the at least one first groove.

28. The wire saw work piece support device according to claim 27, wherein the at least one wire receiving volume further comprises at least one second groove formed in the solid support body, wherein the at least one second groove extends in a second direction along the support plane orthogonal to the first direction.

29. The wire saw work piece support device according to claim 26, further comprising:
a wire saw work piece support spacer comprising a solid material sawable by the wire saw wire, the wire saw work piece support spacer having at least one wire receiving portion filling the at least one wire receiving volume at least partially.

30. The wire saw work piece support device according to claim 29, wherein the wire saw work piece support spacer has a first spacer surface being the support surface; and a second spacer surface opposite the first spacer surface, the second spacer surface being form-fit to a surface profile of the solid support body.

31. The wire saw work piece support device according to claim 26, wherein the support surface is formed as a surface of the support body, and wherein the at least one wire receiving volume is formed as a recess in the support body.

32. The wire saw work piece support device according to claim 26, wherein the wire saw device is a squarer, and wherein the wire saw work piece is an ingot to be sawed by the squarer.

33. A wire saw work piece support spacer adapted for a wire saw work piece support device, the wire saw work piece support spacer having:
a support surface adapted for supporting a work piece being sawed by a wire saw during sawing, the support surface defining a support plane; and
a base surface adapted for being supported by a solid support body of the wire saw work piece support device; and
at least one wire receiving portion defining a respective wire receiving volume for receiving therein a wire of the wire saw having sawn through the work piece, the at least one wire receiving portion being arranged between the support surface and a portion of the base surface, wherein
the at least one wire receiving portion comprises a solid material sawable by the wire saw wire, and wherein
the at least one wire receiving portion has a thickness between the support surface and the base surface portion of at least 60 mm in a direction orthogonal to the support plane.

34. The wire saw work piece support device according to claim 33, wherein the base surface is profiled.

35. The wire saw work piece support spacer according to claim 33, wherein the at least one wire receiving portion is a plurality of wire receiving portions, wherein the wire receiving portions comprise first protrusions extending longitudinally and in parallel to each other in a first direction along the base surface.

36. The wire saw work piece support spacer according to claim 35, wherein the wire receiving portions further comprise second protrusions extending longitudinally and in parallel to each other in a second direction along the base surface and intersecting the first protrusions such as to form a web of protrusions, the second direction being orthogonal to the first direction.

37. The wire saw work piece support spacer according to claim 35, further comprising a joining portion joining the wire receiving portions to each other.

38. Method of using a wire saw work piece support device according to claim 26 for supporting a work piece in a wire saw device.

39. Method of using a wire saw work piece support spacer according to claim 33 for supporting a work piece in a wire saw device.

40. Method of sawing a work piece using a wire saw having a work piece support device and a support spacer, the method comprising:
providing a solid support body of the work piece support device, the solid support body having a spacer support surface;
providing the support spacer, the support spacer having a work piece support surface, a base surface and at least one wire receiving portion defining a respective wire receiving volume for receiving therein a wire of the wire saw, the at least one wire receiving portion being arranged between the support surface and a portion of the base surface, wherein the at least one wire receiving portion comprises a solid material sawable by the wire saw wire;
placing the support spacer with its base surface onto the spacer support surface, so that the support spacer is supported by the solid support body;
placing the work piece onto the work piece support surface of the support spacer, so that the support spacer is sandwiched between the support body and the work piece; and
sawing through at least a portion of the work piece by a sawing wire section of a wire of the wire saw, thereby creating a cut in the work piece, so that at least a part of the sawing wire section leaves the work piece from the cut and is received in the at least one wire receiving portion;
sawing, by the part of the wire section received in the at least one wire receiving portion, into the solid material comprised in the at least one wire receiving portion, thereby creating a cut in the solid material; and
retracing the at least one sawing wire section through the cut in the solid material.

41. Method according to claim 40, wherein the at least one wire receiving volume has a thickness of at least 60 mm.

42. Method according to claim 40, further comprising removing the sawing wire section from the work piece through the cut therein.

43. Method according to claim 40, wherein the wire receiving portion comprises a resin.

44. Method according to claim 40, wherein the at least one sawing wire section is a plurality of sawing wire sections forming a wire web, and wherein the sawing wire sections comprise first sawing wire sections extending in a first direction parallel to each other, the first direction being essentially perpendicular to the sawing direction.

45. Wire saw device, comprising:
a wire saw work piece support device according to claim 26;
a wire saw work piece support spacer according to claim 33, and
a controller having a controller memory, the controller memory having stored thereon program code for performing the method according to claim 40.
